(19) United States
(12) Patent Application Publication
(10) Pub. No.: US 2017/0267785 A1
(43) Pub. Date: Sep. 21, 2017

(54) PROCESS FOR THE CONVERSION OF CELLULOSE

(71) Applicant: BIOECON INTERNATIONAL HOLDING N.V., HOEVELAKEN (NL)

(72) Inventors: JOHAN VAN DEN BERGH, DORDRECHT (NL); Paul O'CONNOR, HOEVELAKEN (NL); LIXIAN LU, EINDHOVEN (NL); IGOR BABICH, ENSCHEDE (NL); JACOBUS JOHANNES LEONARDUS HEINERMAN, ABCOUDE (NL); FERNANDA NEIRA D'ANGELO, EINDHOEVEN (NL); JITENDRA KUMAR CHINTHAQINJALA, EINDHOVEN (NL); MASOUD ZABETI, PIJNACKER (NL); CAECILLA VITASARI, EINDHOVEN (NL)

(73) Assignee: BIOECON INTERNATIONAL HOLDING N.V., HOEVELAKEN (NL)

(21) Appl. No.: 15/532,118

(22) PCT Filed: Nov. 17, 2015
(86) PCT No.: PCT/EP2015/076772

§ 371 Date: Jun. 1, 2017

(30) Foreign Application Priority Data
Dec. 1, 2014 (EP) 14195736.5

(51) Int. Cl. C08B 1/00; C13K 1/02; C10L 1/02; C08H 8/00

(52) U.S. Cl. CPC C08B 1/003; C08H 8/00; C13K 1/02; C10L 1/02; C10L 2200/0469; C10L 2290/06; C10L 2290/541; C10L 2290/544; C10L 2290/548; C10L 2290/542; C10L 2290/547; C10L 2290/02

(57) ABSTRACT

A process for the conversion of a cellulose containing feed comprising the steps of: contacting the cellulose containing feed with a molten salt hydrate and mildly hydrolyzing the cellulose to form a solution of partially hydrolized cellulose, separating one or more components of the partially hydrolyzed cellulose from the solution, converting the separated one or more components of the partially hydrolyzed cellulose in a thermo-catalytic process.

### BACKGROUND OF THE INVENTION

1. Field of the Invention

The present invention relates to a process for converting cellulose in a cellulose containing feedstock such as ligno-cellulosic biomass to platform chemicals. There is a significant interest to use renewable resources for making biobased platform chemicals as replacement for chemicals from petrochemical origin. Known uses are for example fuel additives, fuel replacement, and monomers for biobased polymers. Preferred examples of biomass materials include agricultural wastes, such as bagasse, straw, corn stover, corn husks and the like. Bagasse is the fibrous matter that remains after sugarcane or sorghum stalks are crushed to extract their juice.

Ligno-cellulosic biomass comprises three main components lignin, amorphous hemi-cellulose and crystalline cellulose. The components are assembled in such a compact manner that makes it less accessible and therefore less susceptible to chemical conversion. Amorphous hemi-cellulose can be relatively easily dissolved and hydrolysed, but it is much more difficult to convert cellulose in a cellulose containing feedstock in an low cost process. The very crystalline and stable cellulose, is often also entangled into the lignin, making it poorly accessible to any reactant or catalyst. Only at temperatures above 300° C.-350° C. does the cellulose liquefy and only then can start its catalytic conversion to oil products. At these high temperatures however the mono and oligomeric saccharides produced are easily degraded into char and tar or over-cracked into gas, with as a result that the state-of-the art processes give poor liquid yield (high coke and gas) and are difficult to operate (Plugging by char and tar). Various processes have been proposed for the conversion of a cellulose containing feedstock that all struggle with the above problem.

It is known to convert ligno-cellulosic biomass by thermo-catalytic means, such as pyrolysis, catalytic pyrolysis and via hydrothermal (HTU) and/or solvo-thermal processes. Other processes involve converting the polysaccharide to the monomeric saccharides, in particular glucose, in a molten salt hydrate and then derivatising the monosaccharides to derivatives that can be easily separated from the molten salt hydrate.

2. Description of the Related Art

Pyrolysis processes are for example described in “Fast Pyrolysis of Biomass”—Bridgwater. Catalytic Pyrolysis processes are described in “Biomass utilization possibilities”, P. O'Connor, U.S. Pat. No. 7,901,568B2 and WO2007/128798. HTU and Solvo Thermal Conversion processes are described in “Effects of solvents and catalysts in liquefaction”—Wang et al. and WO2007128800A1.

Pyrolysis generally refers to processes carried out at high temperatures (500° C. to 800° C.) in the absence of oxygen, or with so little oxygen present that little or no oxidation takes place. The resulting liquid products are of poor quality, heavily degraded, and low pH, and require extensive (hydro-) treatment for upgrading to transportation fuels or chemical feedstocks.

Bridgwater describes a fast pyrolysis processes in “Biomass Fast Pyrolysis” (THERMAL SCIENCE: Vol. 8 (2004), No. 2, pp. 21-49). The essential features of a fast pyrolysis process for producing liquids (bio-oil) are: very high heating and heat transfer rates at the reaction interface, which usually requires a finely ground bio mass feed, carefully controlled pyrolysis reaction temperature of around 500° C. and vapour phase temperature of 400° C.-450° C., short vapour residence times of typically less than 2 seconds, and rapid cooling of the pyrolysis vapours to give the bio-oil product. The bio-oil yields is up to 75% wt on dry feed basis. Cyclones are needed for char removal. Residual char leads to product instability problems. The application of the obtained bio-oil is mostly to extract the caloric value by combustion in ovens or turbines or after upgrading as addition to or replacement of transport fuels like diesel or as a feedstock for production of chemicals like glycolaldehyde, levoglucosan.

Sheldrake e. a in Green Chem., 2007, 9, 1044-1046 describe controlled pyrolysis at relatively low temperatures of cellulose to anhydrosugars primarily levoglucosenone using dicationic imidazolium chloride molten salts (ionic liquids) as re-usable media for the dissolution of cellulosic biomass. The yields and selectivity are poor.

In U.S. Pat. No. 7,901,568 a process is disclosed for catalytic pyrolysis conversion of a solid or highly viscous carbon-based energy carrier material to liquid and gaseous reaction products, said process comprising the steps of: a) contacting the carbon-based energy carrier material with a particulate catalyst material b) converting the carbon based energy carrier material at a reaction temperature between 200° C. and 450° C., preferably between 250° C. and 350° C., thereby forming reaction products in the vapor phase.

Hydrothermal Upgrading (HTU) is for example described in WO 02/20699 and refers to processes whereby biomass is reacted with liquid water at elevated temperature (well above 200° C.) and pressure (50 bar or higher). The high temperatures and pressures that are needed to obtain suitable conversion rates make these processes expensive, requiring special high pressure equipment constructed with special metal alloys which for commercial plants, are difficult to operate and have relatively short life times. In addition, the products obtained in HTU processes are heavily degraded because of polymerization and coke formation that take place under the prevailing reaction conditions. The liquid products obtained by HTU processes tend to be highly acidic and corrosive, and unstable.

WO2007128800A1 describes a low-cost process for converting biomass to a liquid fuel using conditions that are mild enough to avoid high equipment and energy costs and/or substantial degradation of the conversion products wherein the biomass is activated to make it more susceptible to conversion by addition of acids, clays, metal oxides etc preferably having catalytic properties in the presence of water and optional solvent and intimate mixing of the mixture for example in an extruder or mill to a slurry. This cellulose containing slurry is then converted by one of the above described conversion processes.

U.S. Pat. No. 4,452,640 discloses a process to dissolve and quantitatively hydrolyze cellulose to glucose without formation of degradation products, using ZnCl₂ solutions. Dissolution was effected with salt solutions, with ZnCl₂ being preferred, at sufficiently large contact time and temperatures of 70° C. to 180° C. After dissolution, the ZnCl₂ concentration was lowered prior to hydrolysis to avoid glucose degradation and subsequently HCl or a similar acid was added to effect complete hydrolysis to glucose. It is described that glucose removal from the ZnCl₂ solution is very difficult and it is suggested to use ion exchange resins for separation. A similar process to convert cellulose to glucose is described in U.S. Pat. No. 4,525,218 wherein, after partial hydrolysis of the cellulose in ZnCl₂, degradation of the glucose is prevented by separating the ZnCl₂ by precipitation of the cellodextrins which then are further hydrolised in the absence of ZnCl₂.

WO2009/112588 describes a process for converting polysaccharides to a platform chemical, said process comprising the steps of: a) dissolving polysaccharides in a inorganic molten salt hydrate with ZnCl₂ being preferred; b) converting the dissolved polysaccharides to monosaccharides typically in the presence of an acid; c) converting the monosaccharides to platform chemicals that are easily separable from the inorganic molten salt hydrate; d) separating the platform chemicals from the inorganic molten salt hydrate. A similar process is described in WO2010/106053.

### BRIEF SUMMARY OF THE INVENTION

There remains a desire for a process that can be operated in a cost-effective way and has one or more of the advantages of lower energy consumption, simpler and less expensive equipment, fewer process steps, fewer auxiliary compounds that need to be added and removed, environmentally more acceptable, producing in a higher yield and with less by-products a reaction product of higher quality that is more suitable for conversion to fuels and chemicals.

According to the invention this has been achieved by claim 1: a process for the conversion of a cellulose containing feed comprising the steps of:
a) contacting the cellulose containing feed with a molten salt hydrate and mildly hydrolyzing the cellulose to form a solution of partially hydrolyzed cellulose,
b) separating one or more components of the partially hydrolyzed cellulose from the solution,
c) converting the separated one or more components of the partially hydrolyzed cellulose in a thermo-catalytic process.

Typically, in the process of the invention the cellulose containing feed is a lignocellulosic biomass comprising cellulose, hemicellulose and lignin. The hemicellulose can be removed before step a) and lignin can also be removed before, during or after step a), but preferably after step a).

The partially hydrolysed cellulose comprises a mixture of glucose and oligomeric cellulose with a relatively small amount of glucose. Oligomeric cellulose are can be dimers (cellobiose) or higher oligomers or mixtures thereof collectively referred to as glucans.

With the present invention cellulose can be converted at mild conditions into monomeric and oligomeric saccharides, which liquefy preferably already at temperatures below 200° C. These liquefied saccharides can be easily separated in a high yield relative to the cellulose in the feed and can be conveniently further converted at low temperatures and/or converted in relatively mild conditions by pyrolysis, catalytic pyrolysis, HTU or solvo-thermal conversion. The contact with catalyst and/or reactant hereby is greatly enhanced, and the operating temperatures can be reduced, resulting in a process which has improved conversion selectivity, less coke and gas production, which is easier to operate because less plugging by char and tar occurs and which requires lower energy consumption. The process does not require the addition of acid and therefore requires simpler and less expensive (lower corrosion resistant) equipment and does not require acid removal steps.

An added advantage of the invention compared to state of the art conversion processes is that the lignin is separated from the cellulose, and that it becomes possible to optimize the conversion conditions of both components separately. The hemicellulose can be simply removed from the biomass first by simple acid treatment or by treatment with a molten salt hydrate at lower concentration as is known in the art.

It has been found that the partially hydrolysed cellulose in some separation techniques can be more easily separated from the molten salt hydrate and is particularly suitable for thermo-catalytic conversion, as will be explained in the following.

The process of the invention has the distinct feature and advantage over the prior art that it does not require full hydrolysis of the cellulose to glucose and, as opposed to the prior art processes, does not require addition of mineral acid (usually HCl) for the conversion of the polysaccharide to monosaccharide. Instead, in certain preferred embodiments of the process of the invention a low conversion to glucose is preferred in view of increased yield in the separation step b). The advantage is that it significantly decreases the raw material costs, increases the overall yield of recovering cellulosed derived chemicals and it also decreases the process complexity as no acid needs to be removed in subsequent steps and in the end the acid does not form a waste product.

### DETAILED DESCRIPTION OF THE INVENTION

### Hydrolising and Dissolving Step a)

In the process of the invention the molten salt hydrate is preferably an inorganic molten salt hydrate, preferably chosen from the group of ZnCl₂, CaCl₂, LiCl or mixtures thereof. Most preferred is that the inorganic molten salt hydrate substantially consists of ZnCl₂ hydrate. Reference is made to the above cited prior art documents for description of details concerning the dissolution and hydrolysis in molten salt hydrates.

Therefore, in the process in step a) the pH is preferably autogenic, meaning that the process is performed with no or substantially no addition of acid and the acidity originates only from the polysaccharide containing feed itself. It is in particular preferred that in step a) no mineral acid is added. Small amount of organic acid would not be such a problem in later process steps but it is also preferred that no organic acid is added as it is not needed in the process and it is less desirable as only partial hydrolysis is desired. The hydrolysed solution may comprise acid originating from hydrolysis of groups on the polysaccharide containing feed, in particular acetic acid originating from acetyl groups. A particular advantage and preferred embodiment of the invention is that in the process no acid removal step is used.

In the process during the mild hydrolyzing in step a), the pH of the molten salt hydrate solvent is between −3 and 7 and preferably the pH is higher than −2.5, more preferably −2. For feedstock not containing acetyl groups, the pH is preferably higher than −2 or more preferably higher than −1.5. Feedstock not containing acetyl groups can be pure cellulose or feedstock from which acetyl groups have been removed (by e.g. treatment with NaOH). Because acetylgroups are more abundant on hemicellulose, the removal of hemicellulose also results in feedstock in which acetyl groups have been substantially removed.

On hydrolysing and dissolving cellulose in a molten salt hydrate medium a chemical equilibrium is formed in the solution between the dissolved cellulose, oligomeric cellulose (cellobiose and higher oligomers) and the monomeric glucose which at certain conditions after a certain amount of time will have equilibrium concentrations in the molten salt hydrate solution. It is however not necessary and also not desirable in view of process economy to wait until equilibrium is achieved. Preferably, the total amount of partially hydrolised cellulose in the solution at the start of step b) is at least 80, preferably 85, more preferably at least 90% and most preferably at least 96% relative to the total amount of cellulose in the feedstock. It is preferred that in step a) the total amount of by-products, i.e. cellulose derived products not including glucose and cellulose oligomers, is below 15, 12, 9, 6 and most preferably below 3 wt %.

In a preferred embodiment, the process of the invention involves mild hydrolysis in mild conditions, in particular a low acidity and preferably low temperatures optionally in combination with a short time, to achieve partial hydrolysis of the cellulose, preferably to oligomeric cellulose with low amounts of glucose, with low impurity levels but also a very high degree of dissolution of the cellulose from the biomass. Herein it is preferred that the mild hydrolyzing step a) forms a liquid solution wherein the amount of glucose is less than 50 wt % relative to the total weight of the partially hydrolysed cellulose, preferably less than 40, 30, 20 or even 10 wt %. This embodiment is particularly advantageous in view of achieving high yield in particular in precipitation step b) and low by-product formation.

In an alternative embodiment, the process of the invention involves mild hydrolysis to achieve partial hydrolysis of the cellulose with however substantial glucose formation, preferably in an amount of more than 10, 20, 40, 60 or even more than 70 wt %. The amount of glucose is typically limited to 90, 80, 70 or 60 wt % relative to the partially hydrolysed cellulose. In mild conditions small amount of side product like furans are formed. In this embodiment the production of glucose is optimised and glucose is separated for conversion in process step c). This embodiment has the advantage that glucose in step c) can be converted in even better defined mild conditions at higher yield and purity. The oligomeric cellulose can either be recycled or be treated in step c) separately under conditions specifically optimised in yield and purity for the oligomers.

In general it is possible to perform dissolution and hydrolysis in molten ZnCl₂ hydrates comprising 60-80 wt % of salt at temperatures between 70° C. and 180° C. It was found that best results could be obtained when the ZnCl₂ salt is present in the molten salt hydrate in an amount between 62 and 78, more preferably between 65 and 75 and most preferably between 67.5 and 72.5 wt % relative to the weight of the molten salt hydrate.

In the hydrolysing step a) the temperature is preferably between 90° C. and 120° C., more preferably between 95° C.-110° C. These temperature ranges apply at atmospheric pressure, but lower temperatures can be used at higher pressures, which is an advantage in view of avoiding side reactions but also means a more expensive process. Therefore atmospheric pressure processes are preferred. At too high temperatures by-products are formed and too low temperatures the reaction proceeds slow and more reaction time is needed. The chosen time can also depend on the morphology of the feedstock. The reaction time is chosen high enough to achieve a high degree of dissolution, preferably at least 80, 90 or even 95 wt % at the given temperature. Preferably, the reaction time in step a) is between 5-25 minutes. Typically a dissolution time of between 10 and 25 minutes is chosen at temperatures between 95° C.-110° C. and between 5 and 15 minutes at temperatures between 100° C.-120° C.

Furthermore, it is preferred that the mass ratio of cellulose containing feed relative to molten salt hydrate is between 1/5 and 1/30, preferably 1/5 and 1/20 and most preferably between 1/5 and 1/7. Increasing the concentration of saccharides relative to ZnCl₂ solution resulted in an increased oligomers in the reaction product and lower amounts of glucose. For ratios of saccharides to molten salt hydrate higher than 1/12, preferably higher than 1/7, significant amounts of oligomers are formed in the equilibrium.

It is important that the molten salt hydrate is not diluted with water. Water can be contained in the biomass. Therefore the biomass is preferably dried preferably to a water content below 15, 10, 7, 5, 3 wt %. the process the total amount of water present in step a) is preferably between 20 and 40 wt %, preferably 25 and 35 wt % relative to the total weight of the cellulose containing feed and the inorganic molten salt.

It is preferred to remove hemicellulose from the biomass, for example by using a more dilute ZnCl₂ solution or a dilute acid such that cellulose is not dissolved; for example hydrolysis of real biomass (e.g. bagasse) with 30% ZnCl₂. However, it is also possible to leave hemicellulose in the biomass and subject the cellulose containing biomass as is, i.e. including the hemicellulose, to the partial hydrolysis step b). The term partial hydrolysing in step b) refers to partial hydrolysation of cellulose and in case in step b) the cellulose is partially hydrolised the hemicellulose will be substantially completely hydrolysed.

The lignin is preferably removed by filtration after step a) and before step b). Compared to conversion processes of the prior art it is an advantage that lignin is removed before step c) because not only this allows separate optimisation of further lignin processing, but it removes a major cause and source of char and other by product formation during thermo-catalytic conversion.

### Separation Step b)

A particular advantage of the invention is that it is obtained free from mineral acid, and hence can be used in the subsequent conversion step without substantial work-up resulting in an economically attractive high yield process with low amount of by-products. When the cellulose is only partially hydrolised it is also possible to separate a high amount of the cellulosic material from molten salt hydrate solution.

In the process step b) different options exist. One option is a process wherein substantially all components of the partially hydrolysed cellulose are separated in step b) for subsequent conversion in step c). Another option is a process wherein mostly oligomeric cellulose components are separated in step b) for conversion in step c). In yet another option the glucose is separated from the solution for conversion in step c) or glucose is recycled together with the molten salt hydrate to step a) or b). The choice of the options depend on the chosen type of separation process in step b), the chosen conversion process in step c) and on whether the amount of glucose formed in step a) is sufficient to consider removal of glucose before step c).

The separation in step b) can be done using one or more processes chosen from the group of
a. precipitation of one or more components of the partially hydrolysed cellulose,
b. selective absorption of one or more components of the partially hydrolysed cellulose,
c. extraction of the inorganic molten salt hydrate,
d. precipitation of the inorganic molten salt hydrate,
e. complexation and precipitation of the inorganic molten salt hydrate
f. electrodialysis,
g. membrane separation.

In a preferred embodiment of the process the separation of the partially hydrolysed cellulose in step b) is done by adding an anti-solvent to the solution obtained in step a) to precipitate at least the oligomeric cellulose components of the partially hydrolysed cellulose. Suitable an anti-solvents are water, hydrocarbons, ketones (preferably acetone or propanone), ethers (preferably dimethyl or diethyl ether, dioxane and tetrahydrofuran), alkyl esters of organic acids (preferably acetates), alcohols (preferably ethanol, methanol or isopropanol), formamides, aromatic solvents and mixtures thereof. Preferably at least 75%, 80, 85 and most preferably at least 90% of the oligomers are recovered in the precipitate. From economic viewpoint it is most advantageous to use part of the product obtained in step c) as the anti-solvent for precipitation and separation of oligomers in step b). In that way the process does not need addition of expensive anti-solvent but also the need to separate and recover the anti-solvent is reduced, so the process can be done without separation or without complete separation of anti-solvent.

Disaccharides and higher oligomers precipitate very easily and fast, whereas the monosaccharides precipitate more slowly. It is possible to recover all of oligomers without monosaccharides using small amounts of anti-solvent, which presents the economic advantage that only relatively small amounts of anti-solvent need to be used and to be recovered.

Mono-saccharides can be left in the solution for recycling and will participate in the equilibrium in hydrolysis and dissolution of the cellulose in the biomass in step a). It is also an advantage that oligomer precipitation can be achieved in a short precipitation time and using a short precipitation time is advantageous not only in terms of process economy but also because it is more selective towards oligomers.

In another embodiment of the invention the glucose is separated from the solution obtained in step a) or from the separated partially hydrolysed cellulose obtained in step b). This can be done by a separate subsequent precipitation step or by selective adsorption in chromatography, simulated moving bed or moving bed process or by a batch process comprising adsorption, filtration and desorption steps. It is also possible to adsorb both glucose and oligomeric cellulose, for example with carbon black, and separate that from the solution. In a particular embodiment in the separation of the partially hydrolysed cellulose in step b) an adsorbent is used that also is a catalyst for the subsequent conversion in step c).

Alternatively, the inorganic molten salt hydrate is separated from the solution using one or more processes from the group consisting of dioxane precipitation, ammonia complexation and precipitation, membrane separation, adsorption on ion exchange resins, electrodialysis, liquid/liquid extraction with a selective organic solvent.

In the alternative embodiment wherein mild hydrolysis is done to achieve partial hydrolysis of the cellulose with however substantial glucose formation in an amount of more than 10, 20, 40, 60 or even more than 70 wt % the glucose is separated in step b) for conversion in process step c). Glucose can (I) be removed selectively with recycle of the oligomeric cellulose to step a) or (II) glucose and oligomeric cellulose are both separated from the solution in step b) either by (IIa) sequential separation or (IIb) by simultaneous separation followed by separation of oligomeric cellulose from the glucose.

### Conversion Step c)

After separation step b) the obtained separated partially hydrolysed cellulose is subjected in step c) to a thermo-catalytic process, preferably selected from the group of pyrolysis processes, catalytic pyrolysis processes, hydrothermal processes or solvo-thermal processes or combinations thereof. These processes result in deoxygenated saccharides which have value as platform chemicals.

It is a great advantage of the present invention over the prior art thermo-catalytic processes that because of the process steps a) and b) the conversion in step c) can be performed in mild conditions, i.e. at significantly lower temperatures and/or in significantly shorter exposure times at such temperatures. Preferably the temperature during conversion is between 150° C. and 300° C., preferably between 150° C. and 275° C., 175° C. and 250° C., 175° C. and 225° C. and preferably at atmospheric pressure. The exposure times are chosen to achieve acceptable conversion without substantial side product formation. Specific embodiments of the conversion processes are described in the prior art references described above.

The platform chemicals that are obtained in the catalytic pyrolysis process step c) are depending on the specific process and process conditions used but generally are deoxygenated saccharides, which are also referred to as low oxygen bio-oil. These deoxygenated saccharides can be used as fuels, as fuel additive or as starting material for synthesis of other useful compounds including polymers. The advantage of the process of the invention is that less side products, in particular char are formed compared to conventional processes starting from biomass.

### EXAMPLES

The following is a description of certain embodiments of the invention, given by way of example only.

### Production Example 1

In production example 1, bagasse was hydrolysed and dissolved in Zinc chloride hydrate in mild conditions producing with mostly gluco-oligomers and minimum glucose monomers. Generally a yield of less than 5% of glucose monomers was achieved at a very high dissolution yield. The results show that maximized gluco-oligomers production was achieved when no acid was added to the solution. Comparative experiments with 0.1 wt % HCl or 2 wt % acetic acid (using 70% ZnCl₂ at 80° C.-90° C.) showed a large amount of glucose formation in short time. The effect of the ZnCl₂ concentration and of the hydrolysis/dissolution temperature was measured at ZnCl₂ concentration 70% measured at temperatures 92° C., 100° C. and 110° C. and at ZnCl₂ concentration 65% at temperatures 92° C., 100° C. and 110° C.

The feedstock was bagasse obtained from Brazil. The bagasse was washed with water at room temperature to remove water soluble component. After the washing the bagasse feedstock comprised hemicellulose, cellulose and lignin had the following composition in weight % on a dry basis as determined by analytical method NREL/TP-510-42618 as established by NREL (USA).

| Xylan | Glucan | Arabinan | Acetate | lignin | Ashes | ASL | Total |
|---|---|---|---|---|---|---|---|
| 25.80% | 42.59% | 1.97% | 4.68% | 23.40% | 0.48% | 1.08% | 100% |

A glucan molecule is a polysaccharide of D-glucose monomers. Xylans are polysaccharides made from units of xylose. Arabinan is a polysaccharide that is mostly a polymer of arabinose. Lignin, a large polyaromatic compound, is the other major component of biomass. Part of lignin which is dissolved under the conditions of NREL analysis is referred as acid soluble lignin (ASL). Acetate is produced during hydrolysis of acetyl groups on the polysaccharides,

The bagasse was washed with water, milled in a Retsch SM100 knife mill equipped with a 4 mm screen, dried at 40° C. in an air oven to a water level below 6 wt %. Composition of the solvent and ratio bagasse to solvent is specified below in the Table 1. Typically, the solvent was heated to the specified reaction temperature, the required amount of solid material (bagasse) was added into the reactor and kept at that temperature for the reaction time under mild mixing (if other not specified). In a reactor as specified below 1000 gr of ZnCl₂ solution with a salt content as specified in the Tables was placed in the reactor and heated to the specified reaction temperature with mild mixing or as indicated in Table 5 without mixing. The 2 L reactor mentioned in Table 1 and 2 is a jacketed glass reactor with circulating water as heat carrier. The tubular reactor mentioned in Table 3 and 5 is a Swagelok tubular reactor with 15 ml in volume. An amount of 10 gr of the obtained dry milled bagasse was added to the preheated solvent in an amount to give a solid liquid ratio S/L (i.e. solid dry bagasse/liquid molten salt hydrate) as specified in the tables. The counting of the reaction time started after addition of the bagasse. After a certain reaction time as specified in the tables the reaction was stopped by cooling the reaction mixture to room temperature. No influence of the type of reactor was observed in these experiments.

The resulting reaction product was analysed by filtration of undissolved bagasse over filter 50 micrometer. The obtained solution was brown color viscous liquid. A sample of said solution was analysed using Agilent Infinity HPLC equipped with RID and UV-VIS detectors using a Biorad Aminex HPX-87H Column. The analysis results are given in Tables 1 to 5. In Table 4 and 5 the ration S/L is 1/20, 1/10 which means that per each 1 gr bagasse 20 or 10 gr solution was added, respectively. The total amount of dissolved glucan and xylan was determined based on corresponding sugar (glucose and xylose) analysis in the hydrolyzate liquid obtained after filtration of non-dissolved solids with 50 mkm filter and further treatment under conditions which provides complete hydrolysis of the dissolved carbohydrates. under after complete hydrolysis of

TABLE 1
70% ZnCl₂, 92° C.

| ZnCl₂ | | Acid | Temp (C.) | S/L ratio | Reactor | Mixing | | Filtration | |
|---|---|---|---|---|---|---|---|---|---|
| 70% | | No acid | 92° C. | 1/20 | 2 L | Mild | | 50 micro | |
| | | | | | reactor | mixing | | filter | |
| | Xylan | | | | Glucan | | | | |
| | | | | Total | | | | | Total |
| | | Xylose | | dissolved | | Glucose | | | dissolved |
| Time | Xylose | oligomers | furfural | xylan | Glucose | oligomers | AHG | HMF | glucan |
| 15 min | 45.9% | N.A. | 0.0% | N.A. | 0.5% | N.A. | | 0.0% | N.A. |
| 20 min | 48.0% | 49.2% | 0.0% | 97.2% | 0.0% | 73.5% | | 0.0% | 73.5% |
| 30 min | 54.0% | 45.4% | 0.0% | 99.4% | 0.8% | N.A. | | 0.0% | N.A. |
| 40 min | 68.9% | N.A. | 0.8% | N.A. | 2.0% | 92.8% | | 0.0% | 94.8% |
| 50 min | 76.8% | N.A. | 1.0% | N.A. | 2.8% | N.A. | | | N.A. |

TABLE 2
70% ZnCl₂, 100° C.

| ZnCl₂ | | Acid | | Tem. | S/L ratio | | Reactor | Mixing | Filtration | |
|---|---|---|---|---|---|---|---|---|---|---|
| 70% | | No acid | | 100° C. | 1/10 | | 2 L | Mild | 50 micro | |
| | | | | | | | reactor | mixing | filter | |
| | | Xylan | | | | Glucan | | | | |
| | | | | | Total | | | | | Total |
| | | | Xylose | | dissolved | | Glucose | | | dissolved |
| Time¹ | | Xylose | oligomers | furfural | xylan | Glucose | oligomers | AHG | HMF | glucan |
| 5 | min | 34.2% | 40.4% | 0.2% | 74.8% | 0.3% | 81.4% | 0.0% | 0.0% | 81.7% |
| 10 | min | 44.7% | 52.6% | 0.3% | 97.6% | 0.9% | 89.5% | 0.1% | 0.0% | 90.5% |
| 15 | min | 64.0% | 34.0% | 0.7% | 98.7% | 2.6% | 92.2% | 0.1% | 0.0% | 94.9% |
| 20 | min | 64.7% | NA | 1.1% | NA | 5.0% | NA | 0.3% | 0.1% | NA |
| 40 | min | 64.9% | 31.7% | 2.9% | 99.5% | 19.4% | 77.8% | 1.2% | 0.2% | 98.6% |

TABLE 3
70% ZnCl₂, 110° C.

| ZnCl₂ | Acid | | Tem. | S/L ratio | Reactor | | Mixing | Filtration | |
|---|---|---|---|---|---|---|---|---|---|
| 70% | No acid | | 100° C. | 1/10 | Tubular | | Mild | 50 micro | |
| | | | | | reactor | | mixing | filter | |
| | Xylan | | | | Glucan | | | | |
| | | | | Total | | | | | Total |
| | | Xylose | | dissolved | | Glucose | | | dissolved |
| Time¹ | Xylose | oligomers | furfural | xylan | Glucose | oligomers | AHG | HMF | glucan |
| 10 min | 60.1% | 37.6% | 1.8% | 99.5% | 8.8% | 79.9% | 0.6% | 0.1% | 89.4% |
| 15 min | 81.8% | NA | 3.3% | NA | 18.2% | NA | 1.3% | 0.1% | NA |
| 40 min | 61.8% | NA | 16.9% | NA | 55.2% | NA | 4.2% | 1.1% | NA |
| 60 min | 45.5% | NA | 21.8% | NA | 48.8% | NA | 3.7% | 1.8% | NA |

TABLE 4
65% ZnCl₂, 92° C.

| ZnCl₂ | Acid | | Tem. | S/L ratio | | Reactor | Mixing | Filtration | |
|---|---|---|---|---|---|---|---|---|---|
| 65% | No acid | | 92° C. | 1/20, 1/10 | | Tonado | Mild | 50 micro | |
| | | | | | | reactor | mixing | filter | |
| | Xylan | | | | Glucan | | | | |
| | | | | Total | | | | | Total |
| | | Xylose | | dissolved | | Glucose | | | dissolved |
| Time¹ | Xylose | oligomers | furfural | xylan | Glucose | oligomers | AHG | HMF | glucan |
| 15 min | 3.9% | N.A. | 0.0% | N.A. | 0.0% | N.A. | 0.0% | 0.0% | N.A. |
| 20 min | 11.6% | 85.6% | 0.0% | 97.2% | 0.0% | 63.4% | 0.0% | 0.0% | 63.4% |
| 30 min | 27.7% | N.A. | 0.0% | N.A. | 0.0% | N.A. | 0.0% | 0.0% | N.A. |
| 40 min | 49.4% | 49.4% | 0.0% | 98.8% | 0.5% | 65.0% | 0.0% | 0.0% | 65.5% |
| 50 min | 42.87% | N.A. | 0.0% | N.A. | 0.00% | N.A. | 0.00% | 0.0% | N.A. |
| 60 min | 49.18% | 49.2% | 0.49% | 98.9% | 0.53% | 60.3% | 0.00% | 0.0% | 60.8% |

TABLE 5
65% ZnCl₂, 120° C.

| ZnCl₂ | | Acid | | Tem. | S/L ratio | | Reactor | Mixing | Filtration | |
|---|---|---|---|---|---|---|---|---|---|---|
| 65% | | No acid | | 120° C. | 1/20, 1/10 | | Tubular | No | 50 micro | |
| | | | | | | | reactor | mixing | filter | |
| | | Xylan | | | | Glucan | | | | |
| | | | | | Total | | | | | Total |
| | | | Xylose | | dissolved | | Glucose | | | dissolved |
| Time¹ | | Xylose | oligomers | furfural | xylan | Glucose | oligomers | AHG | HMF | glucan |
| 5 | min | 72% | 25% | 0% | 97.0% | 3.3% | 61.5% | | 0.00% | 64.80% |
| 10 | min | 64% | 12% | 5% | 81.0% | 12.1% | 30.2% | | 0.13% | 42.43% |
| 15 | min | 60% | 0% | 11% | 71.0% | 21.7% | 14.6% | | 0.44% | 36.74% |
| 20 | min | 64% | 0% | 16% | 80.0% | 29.6% | 19.6% | | 0.79% | 49.99% |
| 25 | min | 65% | 0% | 19% | 84.0% | 28.8% | 19.6% | | 0.83% | 49.23% |

### Production Example 2

The influence of added acid on acidity of a ZnCl₂ was determined on different ZnCl₂ concentration levels for different amounts of added acetic acid (AA) and hydrochloric acid (HCL). The pH was determined using a Metrohm 907 Titrando pH meter. The results are summarised in Table 6.

TABLE 6
pH data

| ZnCl₂ | HCl | | ZnCl₂ | AA | |
|---|---|---|---|---|---|
| wt % | (wt %) | pH | wt % | (wt %) | pH |
| 60.8 | 0 | 0.14 | 70 | 0 | −1.18 |
| 70.9 | 0 | −1.3 | 70 | 0.05 | −1.43 |
| 75.9 | 0 | −1.74 | 70 | 0.1 | −1.77 |
| 59.9 | 1.44 | −2.14 | 70 | 0.2 | −2.15 |
| 69.9 | 1.44 | −3.24 | 70 | 0.5 | −2.47 |
| 74.9 | 1.44 | −3.93 | 70 | 1 | −2.64 |
| 58.9 | 3 | −2.18 | 70 | 2 | −2.79 |
| 68.8 | 3 | −3.38 | | | |
| 73.7 | 3 | −4.02 | | | |

Based on the production examples above, better results are obtained using 70% ZnCl₂ than when using 65% ZnCl₂. Therefore it is preferred to use at least 65 wt % ZnCl₂. At 65% not sufficiently high percentage dissolution to glucans was obtained even at higher temperatures where side product formation started to take place. In case of using 70% ZnCl₂ as solvent, the temperatures and reaction times could remain relatively low with high yield of dissolved glucans and relatively low yield of glucose and the conditions described in Table 7 are recommended.

TABLE 7

| | | | | Total |
|---|---|---|---|---|
| | Retention | | Glucose | dissolved |
| Temperature | time | | yield | Glucan |
| 92° C. | 40 | min | 2.0% | 94.8% |
| 100° C. | 10-15 | min | 0.9-2.6% | 90.5-94.9% |
| 110° C. | <10 | min | 8.8% | 89.4% |

It was observed that optimum results were obtained in a preferred range between 62 and 78 wt %, more preferably between 65 and 75 wt % and most preferably between 67.5 and 72.5 wt % ZnCl₂ (wt % salt in the molten salt hydrate).

### Production Example 3: Separation Step b

The partially hydrolysed cellulose solution obtained in step a) Production example 1 cellulose hydrolysed in 70% ZnCl₂, without addition of acid at 100° C. produced after 15 minutes only 2.6 wt % glucose and 92.2 wt % of oligomers and hardly any side products with a total amount of 94.9 wt % of initial glucans in bagasse being dissolved.

The hydrolysate obtained was mixed with 2.33 parts of 2-butanone to 1 part (mass) of hydrolysate. The oligomers precipitated almost completely and a relatively small amount of the already small amount of glucose precipitated. In total 85 wt % of the total amount of the cellulose in solution was precipitated which was 81 wt % of the original amount of cellulose in the biomass feedstock. The filtrate containing ZnCl₂ and residual un-precipitated saccharide could be reused as solvent without purification.

### Comparative Example 2—Acidic Cellulose Hydrolysis to Hydrolysate

Cellulose was mixed to 12 times its weight of a 70% ZnCl₂ solution containing additional 0.4 molal of HCl and kept at 70° C. After 60 minutes a composition of 75% glucose, 20% cellobiose (a glucose dimer) and less than 5% 1,6-anhydroglucose and oligomers was obtained. The resulting hydrolysate was precipitated with 2.33 parts of 2-butanone to 1 part (mass) of hydrolysate. 91% of the cellobiose and 45.6% of the glucose precipitated.

The total amount of cellulosic material obtained in step a) and b) available for subsequent conversion in this comparative example therefore was 52 wt %. The advantage of the invention shows in that example 3 no less than 85 wt % of the total amount of cellulose in solution was recovered for further conversion (as opposed to 52 wt %) and this was achieved in only 15 minutes of hydrolysis (as opposed to 60 minutes).

What is claimed is:

1. Process for the conversion of ligno-cellulosic biomass comprising the steps of:
a) contacting the ligno-cellulosic biomass with a molten salt hydrate and hydrolyzing the cellulose to form a solution of partially hydrolized cellulose,
b) separating one or more components of the partially hydrolyzed cellulose from the solution,
c) converting the separated one or more components of the partially hydrolyzed cellulose in a thermo-catalytic process.

2. The process of claim 1 wherein preferably the hemicellulose is removed before step a) and lignin preferably is removed after step a).

3. Process according to claim 1 or 2 wherein in the hydrolyzing in step a) the pH of the molten salt hydrate solvent is between −3 and 7, preferably the pH is higher than −2.5, more preferably −2, and for feedstock not containing acetyl groups, in particular cellulose or feedstock from which acetyl groups have been removed or feedstock from which hemicellulose has been removed, the pH is preferably higher than −2 or more preferably higher than −1.5.

4. The process according to anyone of claim 1-3 wherein in step a) the pH is autogenic.

5. The process according to anyone of claims 1-4 wherein in step a) no mineral acid is added.

6. The process according to anyone of claims 1-5 wherein no acid removal step is used.

7. The process according to anyone of claims 1-6 wherein the hydrolyzing step a) forms a liquid solution wherein the amount of glucose is less than 50 wt % relative to the total weight of the partially hydrolysed cellulose, preferably less than 40, 30, 20 or even 10 wt % and wherein the total amount of dissolved cellulose is at least 90%, preferably 93%, more preferably at least 96% relative to the total amount of cellulose in the feedstock.

8. The process according to anyone of claims 1-7 wherein in step a) the temperature is between 90° C. and 120° C. at atmospheric pressure.

9. The process according to anyone of claims 1-8 wherein the reaction time in step a) is between 5-25 minutes.

10. The process according to anyone of claims 7-9 wherein mostly oligomeric cellulose components are separated in step b) for conversion in step c).

11. The process according to anyone of claims 7-9 wherein substantially all components of the partially hydrolysed cellulose are separated in step b) for conversion in step c).

12. The process according to anyone of claims 1-6 wherein the hydrolyzing step a) forms a liquid solution wherein the amount of glucose is more than 20, preferably 30, 40 50 or even 60 wt % relative to the total weight of the partially hydrolysed cellulose and wherein glucose is separated from the solution for conversion in step c).

13. The process according to anyone of claims 1-12 wherein the separation in step b) is done using one or more separation processes chosen from the group of
a. precipitation of one or more components of the partially hydrolysed cellulose,
b. selective absorption of one or more components of the partially hydrolysed cellulose,
c. extraction of the inorganic molten salt hydrate,
d. precipitation of the inorganic molten salt hydrate,
e. complexation and precipitation of the inorganic molten salt hydrate
f. electrodialysis,
g. membrane separation.

14. The process according to anyone of claims 1-13 wherein the separation of the partially hydrolysed cellulose in step b) is done by adding an anti-solvent to the solution obtained in step a) to precipitate at least the oligomeric components of the partially hydrolysed cellulose.

15. The process according to anyone of claims 1-13 wherein glucose is separated from the solution obtained in step a) or from the separated partially hydrolysed cellulose obtained in step b) by subsequent precipitation step or by selective adsorption in chromatography, simulated moving bed or moving bed process or by a batch process comprising absorption, filtration and desorption steps.

16. The process according to anyone of claims 1-13 wherein in the separation of the partially hydrolysed cellulose in step b) an adsorbent is used that also is a catalyst for the subsequent conversion in step c).

17. The process according to anyone of claims 1-13 wherein in the inorganic molten salt hydrate is separated from the solution using one or more processes from the group consisting of dioxane precipitation, ammonia complexation and precipitation, membrane separation, adsorption on ion exchange resins, electrodialysis, liquid/liquid extraction with a selective organic solvent.

18. The process according to anyone of claims 1-17 wherein in step c) the thermo-catalytic process is selected from the group of pyrolysis processes, catalytic pyrolysis processes, hydrothermal processes or solvo-thermal processes or combinations thereof.

19. The process according to anyone of claim 18 wherein in step c) the conversion is performed at a temperature between 150° C. and 300° C., preferably between 175° C. and 275° C., 175° C. and 250° C., 175° C. and 225° C. and preferably at atmospheric pressure.

20. The process according to anyone of claims 1-19 wherein the molten salt hydrate is an inorganic molten salt hydrate, preferably chosen from the group of ZnCl₂, CaCl₂, LiCl or mixtures thereof, preferably the inorganic molten salt hydrate substantially consisting of ZnCl₂ hydrate.

21. The process according to anyone of claims 1-20 wherein the ZnCl₂ salt is present in the molten salt hydrate in an amount between 62 and 78, more preferably between 65 and 75 and most preferably between 67.5 and 72.5 wt %.

22. The process according to anyone of claims 1-21 wherein the mass ratio of cellulose containing feed relative to molten salt hydrate is between 1/5 and 1/30 preferably between 1/5 and 1/10.

23. The process according to anyone of claims 1-22 wherein the total amount of water present in step a) and b) is between 20 and 40 wt %, preferably 25 and 35 wt % relative to the total weight of the polysaccharide containing feed and the inorganic molten salt.
